(19) United States
(12) Patent Application Publication
(10) Pub. No.: US 2025/0190818 A1
(43) Pub. Date: Jun. 12, 2025

(54) PROBABILISTIC REASONING ON KNOWLEDGE GRAPHS USING PATH-BASED SIMULATIONS

(71) Applicant: Microsoft Technology Licensing, LLC, Redmond, WA (US)

(72) Inventor: Harsh SHRIVASTAVA, Redmond, WA (US)

(73) Assignee: Microsoft Technology Licensing, LLC, Redmond, WA (US)

(21) Appl. No.: 18/532,760

(22) Filed: Dec. 7, 2023

(51) Int. Cl. G06N 5/02

(52) U.S. Cl. CPC G06N 5/02

(57) ABSTRACT

The present disclosure relates to methods and systems that perform probabilistic reasoning on knowledge graphs. The systems and methods use path-based simulations over a knowledge graph to convert the knowledge graph into a probabilistic graphical model that supports probabilistic reasoning on the knowledge graph. The systems and methods use the probabilistic graphical model to discover paths of the knowledge graph in response to a query.

### BACKGROUND

Knowledge graphs are used extensively in anything from search engines, product recommendations, autonomous systems, to data science. Knowledge graphs are also extensively used in artificial intelligence (AI) and machine learning applications. Knowledge graphs are used to represent data and may provide insights derived from analysis of the knowledge graphs.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Some implementations relate to a method. The method includes training a probabilistic graphical model using a knowledge graph and a node-path matrix. The method includes receiving a query that identifies a node of the knowledge graph. The method includes using the probabilistic graphical model to identify a path in the knowledge graph relevant to the node in the query. The method includes providing an output of the path in the knowledge graph in response to the query.

Some implementations relate to a device. The device includes a processor; memory in electronic communication with the processor; and instructions stored in the memory, the instructions being executable by the processor to: train a probabilistic graphical model using a knowledge graph and a node-path matrix; receive a query that identifies a node of the knowledge graph; use the probabilistic graphical model to identify a path in the knowledge graph relevant to the node in the query; and provide an output of the path in the knowledge graph in response to the query.

Some implementations relate to a method. The method includes receiving a selection of a knowledge graph. The method includes running a plurality of path-based simulations on the knowledge graph. The method includes generating a normalized node-path matrix in response to running the plurality of path-based simulations on the knowledge graph. The method includes training a probabilistic graphical model using the normalized node-path matrix and the knowledge graph.

Some implementations relate to a device. The device includes a processor; memory in electronic communication with the processor; and instructions stored in the memory, the instructions being executable by the processor to: receive a selection of a knowledge graph; run a plurality of path-based simulations on the knowledge graph; generate a normalized node-path matrix in response to running the plurality of path-based simulations on the knowledge graph; and train a probabilistic graphical model using the normalized node-path matrix and the knowledge graph.

Additional features and advantages will be set forth in the description which follows, and in part will be obvious from the description, or may be learned by the practice of the teachings herein. Features and advantages of the disclosure may be realized and obtained by means of the instruments and combinations particularly pointed out in the appended claims. Features of the present disclosure will become more fully apparent from the following description and appended claims or may be learned by the practice of the disclosure as set forth hereinafter.

### BRIEF DESCRIPTION OF THE DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 illustrates an example environment for discovering pathways in knowledge graphs in accordance with implementations of the present disclosure.

FIGS. 2A, 2B, and 2C illustrate example knowledge graphs for use with implementations of the present disclosure.

FIG. 3 illustrates an example normalized node-path matrix generated in response to running path-based simulations on a knowledge graph in accordance with implementations of the present disclosure.

FIG. 4 illustrates an example method for learning one example of a probabilistic model, a Neural Graphical Model, in accordance with implementations of the present disclosure.

FIG. 5 illustrates an example method for performing probabilistic reasoning on knowledge graphs using a probabilistic graphical model in accordance with implementations of the present disclosure.

FIG. 6 illustrates components that may be included within a computer system.

### DETAILED DESCRIPTION

This disclosure generally relates to probabilistic reasoning on knowledge graphs. Knowledge graphs are used extensively in anything from search engines, product recommendations, autonomous systems, to data science. Knowledge graphs are also extensively used in artificial intelligence (AI) and machine learning applications. Knowledge graphs may include a large number of nodes and edges and it may be difficult for users to figure out paths in the knowledge graphs or identify areas of interest in the knowledge graphs.

The systems and methods of the present disclosure identify implicit information hidden in the paths that connect the nodes of the knowledge graphs and develop a methodology to extract this information. The systems and methods of the present disclosure perform probabilistic reasoning on knowledge graphs. The systems and methods use path-based simulations over a knowledge graph to convert the knowledge graph into a probabilistic graphical model that supports probabilistic reasoning on the knowledge graph. The systems and methods use the probabilistic graphical model to discover important parts of the knowledge graph or areas of interest in the knowledge graph. The present disclosure includes a number of practical applications that provide benefits and/or solve problems associated with probabilistic reasoning on knowledge graphs. Examples of these applications and benefits are discussed in further detail below.

The systems and methods of the present disclosure use the probabilistic graphical model to discover important paths present in the knowledge graph. For example, important paths include biological pathways that connect genotypes to phenotypes in bioinformatics knowledge graphs, or in a map of a country, important paths identify the most critical routes connecting various cities. Such information can be helpful in system designing and gathering actionable insights. The systems and methods run extensive path-based simulations and record the node occurrences of the nodes identified in the simulated paths in a node-path matrix. The systems and methods use the information in the node-path matrix to learn a probabilistic graphical model over the knowledge graph.

Probabilistic graphical models are used to capture dependencies between features and learn the underlying distribution from the knowledge graph. By using probabilistic graphical models, the methods and systems allow the users to perform counterfactual reasoning over a knowledge graph. Learning, inference, and sampling are operations that make probabilistic graphical models useful for domain exploration. Learning, in a broad sense, consists of fitting the distribution function parameters from data. Inference is the procedure of answering queries in the form of marginal distributions or reporting conditional distributions with one or more observed variables. Sampling is the ability to draw samples from the distribution defined by the probabilistic graphical model.

In some implementations, the probabilistic graphical models are Neural Graphical Models. Neural Graphical Models are a type of probabilistic graphical model that advances state-of-the-art by their ability to capture highly non-linear dependencies between features. Neural Graphical Models are probabilistic graphical models that utilize the expressive power of neural networks to learn complex non-linear dependencies between the input attributes. Neural Graphical Models learn to capture the underlying data distribution and have efficient algorithms for inference and sampling. Neural Graphical Models are a type of probabilistic graphical model that handle complex distributions over a domain and represents a richer set of distributions as compared to traditional probabilistic graphical models. Neural Graphical Models remove the restrictions previously placed over a domain by traditional probabilistic graphical models. Neural Graphical Models represent complex distributions without restrictions on the domains or predefined assumptions about the domains and may capture high distributions defined by the data for a domain.

Neural Graphical Models accept a feature dependency structure that can be given by an expert or learned from data. The dependency structure may have the form of a graph with clearly defined semantics (e.g., a Bayesian network graph or a Markov network graph) or an adjacency matrix. In some implementations, the feature dependency structure is a knowledge graph. The graph may be either directed or undirected. Based on this dependency structure, Neural Graphical Models represent the joint probability distribution over the domain by using expressive power of deep neural networks. The parameterization of such a network can be learned from data efficiently, with a loss function that jointly optimizes adherence to the given dependency structure and fit to the data. Probability functions represented by Neural Graphical Models are unrestricted by any of the common restrictions inherent in other probabilistic graphical models.

The Neural Graphical Models represents the functions of the different features using a neural network. The neural network represents the distribution(s) over the domain. The neural network is a deep learning architecture with hidden layers. The functions represented using the neural network capture the dependencies identified in the dependency structure. The functions are represented in the neural network by the paths from nodes in the input layer through the neural network hidden layer(s) to the node in the output layer. Thus, as the number of neural network layers increases in the neural view and/or the number of units in each hidden layer increase, the complexity of the functions represented by the neural view increases. The Neural Graphical Models represent complex distributions over features of a domain. Neural Graphical Models learn the underlying probability distribution from multimodal data (e.g., text, images, continuous, categorical, etc.). The Neural Graphical Model has the ability to model with multimodal input data types and may capture any type of data for the domain. Moreover, Neural Graphical Models inference capabilities allow efficient calculation of conditional and marginal probabilities which can answer many complex queries.

The systems and methods use the probabilistic graphical model to perform probabilistic reasoning over paths in the knowledge graph to discover important parts of the knowledge graph or areas of interest in the knowledge graph. Given a knowledge graph, the systems and methods use the probabilistic graphical model to discover important paths present in the knowledge graph or areas of interest in the knowledge graph.

In some implementations, the systems and methods use a pathway discovery tool that a user uses to observe a certain set of nodes in the knowledge graph. The pathway discovery tool figures out (or probabilistically ranks) other nodes present in the knowledge graph based on the node importance of the selected node or nodes. The user identifies one or more nodes in a query and the pathway discovery tool uses the probabilistic graphical model to provide query based relevant paths of the knowledge graph for the one or more nodes identified in the query. An example of an important path includes a path with a node or set of nodes identified by the user in a query. For example, the user provides a query with certain genes and diseases selected as nodes of interest in a knowledge graph and the pathway discovery tool suggests the most likely biological pathways in the knowledge graph that caused the genotype-phenotype connection. The pathway discovery tool aids users in discovering pathways in knowledge graphs.

One example use case of the methods and systems of the present disclosure is a user is a researcher doing experiments. The user identifies a knowledge graph with processes related to the experiments and provides the knowledge graph to the pathway discovery tool. The user also provides a query identifying a node of interest in the knowledge graph. The pathway discovery tool receives the knowledge graph, learns a probabilistic graphical model over the knowledge graph, and uses the probabilistic graphical model to identify pathways in the knowledge graph related to the node in the query. The user may use the identified pathways to understand how the process is occurring in the experiments.

Another use case of the methods and systems of the present disclosure is a user is about to launch a new product campaign. The user identifies a knowledge graph with social connections among individuals who promote products and provides the knowledge graph to the graph discovery tool. The user also provides a query identifying a node of interest (an individual) in the knowledge graph. The pathway discovery tool receives the knowledge graph, learns a probabilistic graphical model over the knowledge graph, and uses the probabilistic graphical model to identify pathways in the knowledge graph related to the node in the query (pathways from the individual to other individuals in the knowledge graph). The user may use the identified pathways to determine which individuals to contact to help promote the new product.

Another use case of the methods and systems of the present disclosure is a user is developing a new drug to treat a disease. The user identifies two knowledge graphs that are of interest (a knowledge graph of countries and different regulations for drug testing and a knowledge graph of drugs related to proteins that target a specific disease). The user provides the knowledge graphs to the graph discovery tool and provides a query with a set of nodes of interest (e.g., a country to test a drug and a protein that targets a disease). The graph discovery tool merges the two graphs together to a single knowledge graph, learns a probabilistic graphical model over the merged knowledge graph, and uses the probabilistic graphical model to identify pathways in the knowledge graph related to the node in the query (pathways with the genotype to phenotype connections and pathways with rules and regulations for testing a new drug in the identified country). The user may use the identified pathways to determine which countries to test the new drug in and then narrow down the drug discovery process.

One technical advantage of the systems and methods of the present disclosure is using deep learning based representations to enhance the querying of the knowledge graphs. Another technical advantage of the systems and methods of the present disclosure is graph structure discovery of the underlying connections within the knowledge graph using probabilistic reasoning. Another technical advantage of the systems and methods of the present disclosure is the ability to handle multimodal data.

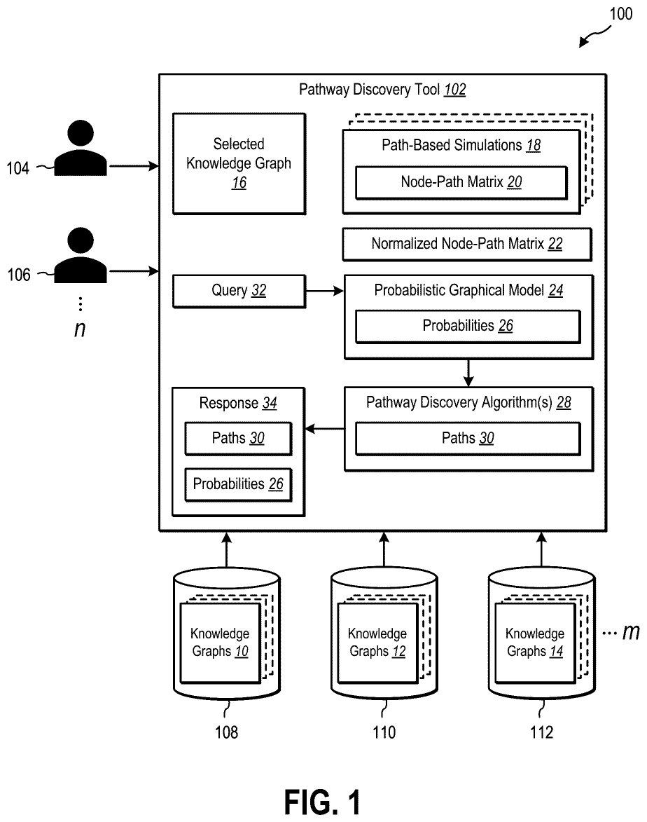

Referring now to FIG. 1, illustrated is an example environment 100 for discovering pathways in knowledge graphs using a probabilistic graphical model 24. The environment 100 includes a pathway discovery tool 102 that aids users (e.g., the users 104, 106 up to n, where n is a positive integer) in performing probabilistic reasoning on knowledge graphs. The pathway discovery tool 102 consists of a machine learning model and a user interface that allows the users 104, 106 to provide a query 32 to the machine learning model (e.g., the probabilistic graphical model 24) and interact with the machine learning model (e.g., the probabilistic graphical model 24). In some implementations, the machine learning model is a Neural Graphical Model. The user interface also includes a response presenter that provides a response 34 to the query 32.

The users 104, 106 access the pathway discovery tool 102 using a computing device. In some implementations, the pathway discovery tool 102 is publicly accessible (or accessible to all users 104, 106). In some implementations, the pathway discovery tool 102 is on a server (e.g., a cloud server) remote from the computing devices of the users 104, 106. In some implementations, the pathway discovery tool 102 is hosted on virtual machines in the cloud. In some implementations, the pathway discovery tool 102 is on an edge device. In some implementations, the pathway discovery tool 102 is local to computing devices of the users 104, 106.

The users 104, 106 identify a knowledge graph of interest (a selected knowledge graph 16). A knowledge graph is a knowledge base that uses a graph-structured data model to represent and operate on data. Knowledge graphs represent a network of entities (e.g., objects, events, situations, or concepts) and illustrates the relationships between the entities. Knowledge graphs include nodes, edges, and labels. Any entity may be a node and edges define the relationships between the nodes. A user may select a knowledge graph of interest based on a problem the user is trying to solve, based on a question the user is trying to answer, or based on a domain that the user wants to explore further. In some implementations, the users 104, 106 provide the selected knowledge graph 16 to the pathway discovery tool 102.

In some implementations, the users 104, 106 select the selected knowledge graph 16 from a plurality of knowledge graphs (e.g., knowledge graphs 10, knowledge graphs 12, knowledge graphs 14 up to m, where m is a positive integer) accessible by the pathway discovery tool 102. In some implementations, the knowledge graphs are accessed from a plurality of datastores (e.g., the datastores 108, 110, 112). Each datastore may contain any number of knowledge graphs from any domain types. For example, the datastore 108 includes knowledge graphs 10 of the pharma or healthcare domain (e.g., knowledge graphs 10 of genes, proteins, diseases, drugs, drug-drug side effects, protein-protein interaction, etc.). Another example is the datastore 110 includes knowledge graphs 12 of a social domain (e.g., knowledge graphs 12 of human interactions, countries connections, social networks, etc.). Another example is the datastore 112 includes knowledge graphs 14 of a process domain (e.g., knowledge graphs 10 of metabolic processes, chemical reactions, organic processes, etc.).

The pathway discovery tool 102 provides a list of available knowledge graphs (e.g., the knowledge graphs 10, 12, 14) and the users 104, 106 select a knowledge graph of interest (the selected knowledge graph 16) from the plurality of knowledge graphs (e.g., the knowledge graphs 10, 12, 14). For example, the user 104 selects the knowledge graph 10 as the selected knowledge graph 16. In some implementations, the user 106 selects two or more knowledge graphs of interest from the plurality of knowledge graphs (e.g., the knowledge graphs 10, 12, 14) and the pathway discovery tool 102 merges the two or more knowledge graphs of interest into a single knowledge graph as the selected knowledge graph 16. In some implementations, the pathway discovery tool 102 uses smart merging to merge the two knowledge graphs into a single knowledge graph. For example, the pathway discovery tool 102 performs term normalization to make sure that the same entity with different names (e.g., USA, United States, United States of America) all are counted as one. Similarly, if nodes along with their associated embeddings are being merged, then the pathway discovery tool 102 uses tools and techniques to merge embedding representations accordingly into a single knowledge graph.

The pathway discovery tool 102 runs one or more path-based simulations 18 (up to k, where k is a positive integer) in response to the user(s) 104, 106 selecting the selected knowledge graph 16 and generates a node-path matrix 20 for each path-based simulation 18 run on the selected knowledge graph 16. The path-based simulations 18 are simulations that the pathway discovery tool 102 performs on the selected knowledge graph 16 to simulate multiple different ways to connect a given set of entities present in the selected knowledge graph 16. The simulations are enumerated for various possible subsets in the knowledge graph 16. Paths are connections between different nodes, often denoted by a chain of nodes. in the selected knowledge graph 16. Different domains may have different paths. For example, in a pharma domain, paths between nodes indicate a genotype to phenotype connection. Another example in a pharma domain includes paths between nodes indicating drugs that target a specific diseases and relations to proteins. Another example in a social domain is paths between countries indicating countries that are neighbors. Another example in a social domain is paths between individuals indicating a relationship between the individuals. Another example in a process domain for a chemical reaction are the paths indicating processes that overlap. The paths are defined by the nodes in the selected knowledge graph 16 and the connections between the nodes.

The node-path matrix 20 identifies a node occurrence for each path identified in the selected knowledge graph 16 during the path-based simulations 18. The node-path matrix 20 includes a value indicating whether a node occurs on the simulated path (e.g., a “1” if a node is found on a path and a “0” if a node is not located on a path). In some implementations, the pathway discovery tool 102 runs a single path-based simulation 18 on the selected knowledge graph 16 and generates a node-path matrix 20. Based on the path-based simulation chosen, associated normalization techniques are applied.

One example path-based simulation 18 is a single-exclusion shortest path. The pathway discovery tool 102 runs a single-exclusion shortest path on the selected knowledge graph 16 and repeats until all pairs of nodes are tried (or until a compute limit is reached). The pathway discovery tool 102 selects a pair of nodes in the selected knowledge graph 16 (e.g., node 1 and node 2) and runs DIJKSTRA'S algorithm. In the shortest path, the pathway discovery tool 102 iteratively removes a node from the path and reruns the DIJKSTRA'S algorithm. The pathway discovery tool 102 records all the paths and the nodes identified in the paths in the node-path matrix 20.

Another example path-based simulation 18 is a personalized page-rank. The pathway discovery tool 102 runs a personalized page-rank on the selected knowledge graph 16 and repeats until all nodes are tried (or until a compute limit is reached). The pathway discovery tool 102 selects a node in the selected knowledge graph 16 and runs a personalized page-rank algorithm and records the node importance value in a node-path matrix 20.

Another example path-based simulation 18 is a random walk based traversals. The pathway discovery tool 102 runs a random walk on a subset of the nodes in the selected knowledge graph 16 and repeats until sufficient number of subset are tried that can cover information about the knowledge graph 16 (or until a compute limit is reached). The pathway discovery tool 102 selects a node in the selected knowledge graph 16 and executes random walks from the node. The pathway discovery tool 102 varies the breadth-first search (BFS) and the depth-first search (DFS) probability values to navigate the selected knowledge graph 16. The pathway discovery tool 102 records the nodes visited on the paths in a node-path matrix 20.

Another example path-based simulation 18 is expert opinions. The expert opinions provide different paths and nodes on the paths for the selected knowledge graph 16. The pathway discovery tool 102 records the nodes on the paths using the expert opinions in a node-path matrix 20.

In some implementations, the pathway discovery tool 102 runs a plurality of path-based simulations 18 on the selected knowledge graph 16 and generates a normalized node-path matrix 22 combining the different node-path matrixes 20 generated for each path-based simulation 18. The values for each node in each path in the normalized node-path matrix 22 is a combination of the values in each node-path matrix 20 generated for each path-based simulation 18 performed by the pathway discovery tool 102. The pathway discovery tool 102 may run any combination of path-based simulations 18 on the selected knowledge graph 16. The pathway discovery tool 102 may run extensive path-based simulations 18 on the selected knowledge graph 16 and recode the node occurrence on the different paths simulated.

The pathway discovery tool 102 converts the selected knowledge graph 16 using the normalized node-path matrix 22 into a probabilistic graphical model 24 that supports probabilistic reasoning. The probabilistic graphical model 24 is trained using the selected knowledge graph 16 which it takes as an input dependency structure and the normalized node-path matrix 22 which acts as the input data. The pathway discovery tool 102 uses the normalized node-path matrix 22 generated from running the one or more path-based simulations 18 on the selected knowledge graph 16 and the selected knowledge graph 16 as input to train the probabilistic graphical model 24. The probabilistic graphical model 24 learns a joint probability distribution of the nodes in the selected knowledge graph 16. The marginal probability represents the distribution of the node importance values. Conditional importance of nodes may also be obtained based on the importance values observed or set for a subset of nodes.

The probabilistic graphical model 24 is used to capture functional dependencies and to learn the underlying distribution from the selected knowledge graph 16. A probabilistic graphical model is a probabilistic model for which a graph expresses the conditional dependence structure between random variables. Probabilistic graphical models use a graph-based representation as the foundation for encoding a distribution over a multi-dimensional space and a graph that is a compact or factorized representation of a set of independencies that hold in the specific distribution. Probabilistic graphical models like Neural Graphical Models can handle multimodal data types. In some implementations, the selected knowledge graph 16 is multimodal data that spans different types of data (e.g., text, images, continuous, categorical, etc.).

The nodes of the probabilistic graphical model 24 are the entities in the knowledge graph and the edges indicate connection between the nodes identified using the normalized node-path matrix 22. An absence of an edge between nodes indicates that the entities are conditionally independent of each other given other variables.

In some implementations, the probabilistic graphical model 24 is a Neural Graphical Model. A Neural Graphical Model is a type of probabilistic graphical model implemented using a deep neural network that handles complex distributions over a domain. A domain is a complex system that is being modeled. The Neural Graphical Model represents complex distributions over the domain without restrictions on the domain or predefined assumptions of the domain. The Neural Graphical Model can model with multimodal input data types (e.g., text, images, continuous, categorical, etc.) and contexts of data and may capture any type of data for the domain. In some implementations, the selected knowledge graph 16 is multimodal data that spans different types of data (e.g., text, images, continuous, categorical, etc.).

The users 104, 106 provide queries 32 to the pathway discovery tool 102 using the user interface of the pathway discovery tool 102 and pathway discovery tool 102 outputs responses 34 to the queries 32 using the user interface of the pathway discovery tool 102. The queries 32 include any question the users 104, 106 ask relating to the selected knowledge graph 16. For example, the queries 32 include questions about a specific node in the selected knowledge graph 16 and the response 34 includes identified paths 30 with the node provided in the queries 32. Another example is the queries 32 include a question about a set of nodes (two or more nodes) in the selected knowledge graph 16 and the response 34 includes a probabilistic rank of other nodes present in the selected knowledge graph 16 based on the node importance in response to the node identified in the query 32. Another example of a query 32 is a question about a genes and disease and the response 34 includes a most likely biological pathway that caused the genotype-phenotype connection.

In some implementations, the query 32 identifies a single node of interest in the selected knowledge graph 16 (e.g., an explore mode). In some implementations, the query 32 identifies two nodes of interest in the selected knowledge graph 16 (e.g., a connect mode). In some implementations, the query 32 identifies three or more nodes of interest in the selected knowledge graph 16 (e.g., a group mode). In some implementations, the query 32 excludes a node or nodes (e.g., nodes to exclude from the paths) in the selected knowledge graph 16. In some implementations, the query 32 includes other information (e.g., exclusion criteria) to consider in identifying the paths 30 in the selected knowledge graph 16.

The pathway discovery tool 102 uses the probabilistic graphical model 24 to provide the responses 34 to the queries 32. The probabilistic graphical model 24 allows the users 104, 106 to query and condition over the values of multiple nodes in the selected knowledge graph 16. Since the probabilistic graphical model 24 learns the probability distribution of the nodes in the selected knowledge graph 16, the probabilistic graphical model 24 may be used to perform inference over any nodes without needing a separate predictive model for each node.

The users 104, 106 select a node or nodes of interest in the selected knowledge graph 16 in a query 32 provided to the pathway discovery tool 102 and the pathway discovery tool 102 uses the probabilistic graphical model 24 to provide probabilities 26 of other nodes present in the selected knowledge graph 16 based on the node importance in response to the node or nodes identified in the query 32. For example, the probabilistic graphical model 24 provides the probabilities 26 (a probability distribution) of the other nodes in the selected knowledge graph 16 conditioned on the node of interest (node identified in the) set to probability as “1” or observed (the node is included in a path). Another example includes the probabilistic graphical model 24 provides the probabilities 26 (a probability distribution) of the other nodes in the selected knowledge graph 16 conditioned on the node of interest (node identified in the query 32) set to “0” (the node is excluded from the path). In some implementations, the pathway discovery tool 102 provides a response 34 with the probabilities 26 in response to the query 32.

The pathway discovery tool 102 runs a probabilistic pathway finder algorithm on the selected knowledge graph 16 using the probabilities 26 provided by the probabilistic graphical model 24 to identify paths 30 in the selected knowledge graph 16 in response to the query 32. In some implementations, the probabilistic pathway finder algorithm sorts the predicted node importance values in identifying the paths 30. In some implementations, the probabilistic pathway finder algorithm runs weighted shortest path algorithms (with optional exclusion variants) to get important pathways. In some implementations, the probabilistic pathway finder algorithm identifies a threshold and considers paths with nodes having a probability value that exceed the threshold of being on the path in identifying the paths 30.

In some implementations, the identified paths 30 include the node or nodes of interest included in the query 32 in response to the query 32 identifying the node or nodes to include in the paths. For example, the node or nodes are set to “1” in the query 32. In some implementations, the identified paths 30 exclude the node or nodes of interest included in the query 32 in response to the query 32 identifying to exclude the node or nodes in the paths. For example, the node or nodes are set to “0” in the query 32.

The pathway discovery tool 102 provides a response 34 to the query 32 with the identified paths 30. In some implementations, the identified paths 30 are important paths of the selected knowledge graph 16 (e.g., paths that include the nodes of interest identified in the query 32, or finding critical pathways that can help in system designing q and actionable intelligence). In some implementations, the identified paths 30 are most likely the path that caused a connection between nodes (entities) in the selected knowledge graph 16. For example, the identified path 30 is the most likely biological pathway that caused a genotype-phenotype connection. Another example includes the identified path 30 is a metabolic process that includes the identified nodes of interest in the query 32.

The pathway discovery tool 102 is used to perform path-based simulations 18 over a selected knowledge graph 16 to convert the selected knowledge graph 16 into a probabilistic graphical model 24 that supports probabilistic reasoning. Probabilistic reasoning over paths can be used by the users 104, 106 to discover important parts of the selected knowledge graph 16.

In some implementations, one or more computing devices (e.g., servers and/or devices) are used to perform the processing of the environments 100. The one or more computing devices may include, but are not limited to, server devices, cloud virtual machines, personal computers, a mobile device, such as, a mobile telephone, a smartphone, a PDA, a tablet, or a laptop, and/or a non-mobile device. The features and functionalities discussed herein in connection with the various systems may be implemented on one computing device or across multiple computing devices. For example, the pathway discovery tool 102 and the datastores 108, 110, 112 are implemented wholly on a computing device. Another example includes one or more subcomponents of the pathway discovery tool 102 and/or the datastores 108, 110, 112 implemented across multiple computing devices. Moreover, in some implementations, one or more subcomponent of the pathway discovery tool 102 and/or the datastores 108, 110, 112 may be implemented are processed on different server devices of the same or different cloud computing networks.

In some implementations, each of the components of the environment 100 is in communication with each other using any suitable communication technologies. In addition, while the components of the environment 100 are shown to be separate, any of the components or subcomponents may be combined into fewer components, such as into a single component, or divided into more components as may serve a particular implementation. In some implementations, the components of the environments 100 and 200 include hardware, software, or both. For example, the components of the environment 100 may include one or more instructions stored on a computer-readable storage medium and executable by processors of one or more computing devices. When executed by the one or more processors, the computer-executable instructions of one or more computing devices can perform one or more methods described herein. In some implementations, the components of the environment 100 include hardware, such as a special purpose processing device to perform a certain function or group of functions. In some implementations, the components of the environment 100 include a combination of computer-executable instructions and hardware.

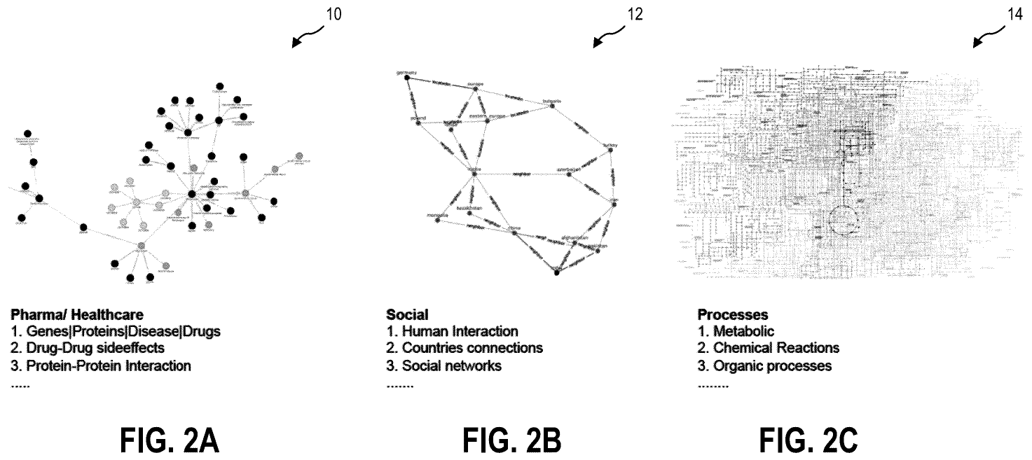

FIG. 2A illustrates an example knowledge graph 10 for use with the pathway discovery tool 102 (FIG. 1). The knowledge graph 10 illustrates an example pharma/healthcare domain knowledge graph.

FIG. 2B illustrates an example knowledge graph 12 for use with the pathway discovery tool 102 (FIG. 1). The knowledge graph 12 illustrates an example social domain knowledge graph. For example, the nodes in the knowledge graph 12 represent different countries and/or locations and the edges represent neighbors of the countries and where the countries are located.

FIG. 2C illustrates an example knowledge graph 14 for use with the pathway discovery tool 102 (FIG. 1). The knowledge graph 14 illustrates an example process domain knowledge graph.

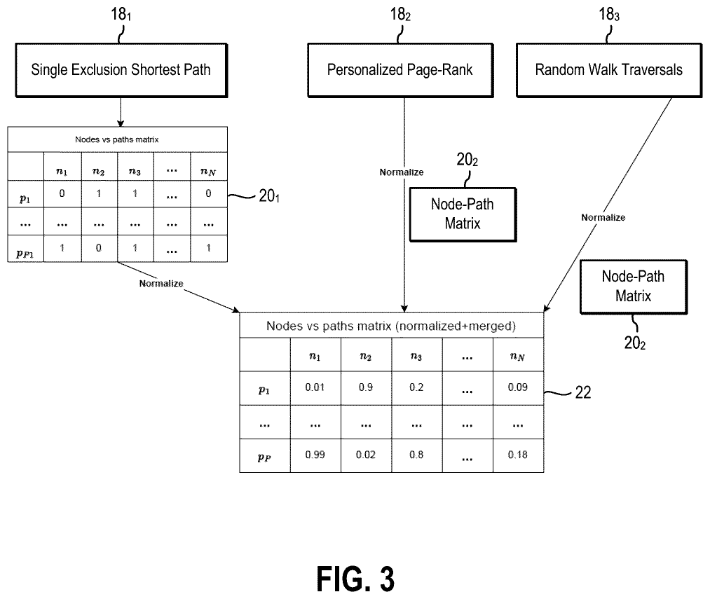

FIG. 3 illustrates an example normalized node-path matrix 22 generated in response to running a plurality of path-based simulations 18 on a knowledge graph. The pathway discovery tool 102 (FIG. 1) runs a plurality of path-based simulations 18 (single-exclusion shortest path 18₁, personalized page-rank 18₂, and random walk traversals 18₃) on the selected knowledge graph 16 (FIG. 1)). The pathway discovery tool 102 generates a node-path matrix 20₁ in response to running a single-exclusion shortest path 18₁ path-based simulation on the selected knowledge graph 16. The node-path matrix 20₁ includes a plurality of paths (p₁ to pₚ (where p is a positive integer)) simulated in the single exclusion shortest path 18₁ path-based simulation and a plurality of nodes in the selected knowledge graph 16 (n₁ to n_{N} (where N is a positive integer)). The node-path matrix 20₁ includes a “1” if the node is on the simulated path and a “0” if the node is not located on the simulated path. For example, nodes n₂ and n₃ are located on the simulated path p₁ and node n₁ is not located on the simulated path p₁.

The pathway discovery tool 102 generates a node-path matrix 20₂ in response to running the personalized page-rank 18₂ path-based simulation on the selected knowledge graph 16. The node-path matrix 20₂ includes a plurality of paths simulated in the personalized page-rank 18₂ path-based simulation and a plurality of nodes in the selected knowledge graph 16. The node-path matrix 20₂ includes a “1” if the node is on the simulated path(s) and a “0” if the node is not located on the simulated path(s).

The pathway discovery tool 102 generates a node-path matrix 20₃ in response to running the random walk traversals 18₃ path-based simulation on the selected knowledge graph 16. The node-path matrix 20₃ includes a plurality of paths simulated in the random walk traversals 18₃ path-based simulation and a plurality of nodes in the selected knowledge graph 16. The node-path matrix 20₃ includes a “1” if the node is on the simulated path(s) and a “0” if the node is not located on the simulated path(s).

The pathway discovery tool 102 merges the different node-path matrixes 20₁, 20₂, and 20₃ generated in response to running the different path-based simulations 18 (single-exclusion shortest path 18₁, personalized page-rank 18₂, and random walk traversals 18₃) on the selected knowledge graph 16 into a single normalized node-path matrix 22. The normalized node-path matrix 22 combines the different paths from the different node-path matrixes 20₁, 20₂, and 20₃ into the normalized node-path matrix 22. If the paths are the same in the node-path matrixes 20₁, 20₂, and 20₃, the pathway discovery tool 102 averages the values for the nodes on the paths and includes the average value in the normalized node-path matrix 22. If the paths are different in the node-path matrixes 20₁, 20₂, and 20₃, the pathway discovery tool 102 adds the paths and the values to the normalized node-path matrix 22. The normalized node-path matrix 22 records the node occurrence on the different paths simulated on the selected knowledge graph 16 by running the different path-based simulations 18 on the selected knowledge graph 16.

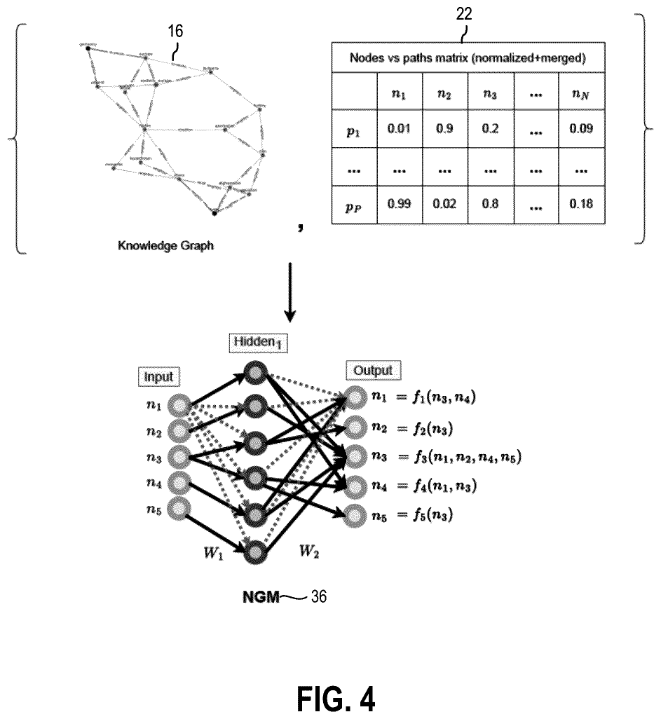

FIG. 4 illustrates an example method 400 for learning one example of a probabilistic model, a Neural Graphical Model 36. The pathway discovery tool 102 provides the selected knowledge graph 16 and the normalized node-path matrix 22 as input to the Neural Graphical Model 36. The Neural Graphical Model learns the functions (e.g., the functions f₁, f₂, f₃, f₄, f₅) for each of the nodes (e.g., the nodes n₁, n₂, n₃, n₄, n₅) in the selected knowledge graph 16. The functions (f₁, f₂, f₃, f₄, f₅) are the paths between the nodes (n₁, n₂, n₃, n₄, n₅) determined by using the node occurrence values in the normalized node-path matrix 22. The pathway discovery tool 102 converts the selected knowledge graph 16 using the normalized node-path matrix 22 into a probabilistic graphical model 24 (e.g., the Neural Graphical Model 36) that supports probabilistic reasoning over the selected knowledge graph 16.

The Neural Graphical Model 36 can model multimodal input data types (e.g., text, images, continuous, categorical, etc.) and contexts of data and may capture any type of data for the domain. In some implementations, the selected knowledge graph 16 is multimodal data that spans different types of data (e.g., text, images, continuous, categorical, etc.). In some implementations, the pathway discovery tool 102 uses the Neural Graphical Model 36 to respond to queries 32 (FIG. 1) of the users 104, 106 (FIG. 1) to identify query relevant paths 30 (FIG. 1) in the selected knowledge graph 16.

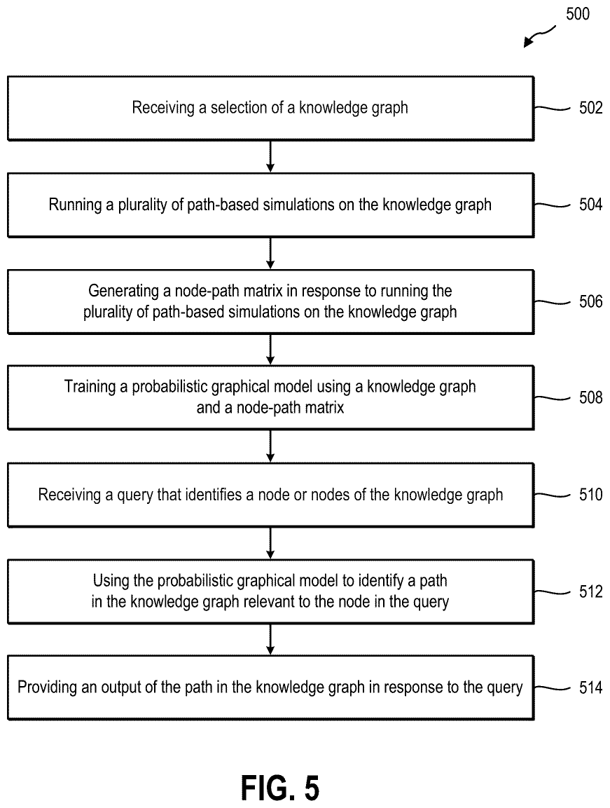

FIG. 5 illustrates an example method 500 for performing probabilistic reasoning on a knowledge graph (e.g., the selected knowledge graph 16 (FIG. 1)) using a probabilistic graphical model 24 (FIG. 1). The actions of the method 500 are discussed below with reference to FIGS. 1-4.

At 502, the method 500 includes receiving a selection of a knowledge graph. The pathway discovery tool 102 receives a selection of a knowledge graph 16 from a user 104 or a user 106. In some implementations, the users 104, 106 provide the selected knowledge graph 16 to the pathway discovery tool 102.

In some implementations, the users 104, 106 select the selected knowledge graph 16 from a plurality of knowledge graphs (e.g., knowledge graphs 10, knowledge graphs 12, knowledge graphs 14). The pathway discovery tool 102 provides a list of available knowledge graphs (e.g., the knowledge graphs 10, 12, 14) and the user 104 selects a knowledge graph of interest (the selected knowledge graph 16) from the plurality of knowledge graphs (e.g., the knowledge graphs 10, 12, 14).

In some implementations, the users 104, 106 select two or more knowledge graphs of interest from the plurality of knowledge graphs (e.g., the knowledge graphs 10, 12, 14) and the pathway discovery tool 102 merges the two or more knowledge graphs of interest into a single knowledge graph as the selected knowledge graph 16. In some implementations, the plurality of knowledge graphs (e.g., the knowledge graphs 10, 12, 14) are from different domains. In some implementations, the plurality of knowledge graphs (e.g., the knowledge graphs 10, 12, 14) include different content or data types (e.g., text, images, continuous, categorical, etc.).

At 504, the method 500 includes running a plurality of path-based simulations on the knowledge graph. The pathway discovery tool 102 runs a plurality of path-based simulations 18 on the selected knowledge graph 16. The plurality of path-based simulations 18 simulate multiple different connections between possible subsets of nodes in the selected knowledge graph 16 and identify nodes in the selected knowledge graph 16 on the different simulated connections in a node-path matrix 20. The pathway discovery tool 102 may run extensive path-based simulations 18 on the selected knowledge graph 16 and recode the node occurrence on the different connections simulated.

The plurality of path-based simulations 18 randomly select two nodes in the selected knowledge graph 16 and records the nodes identified on a simulated connection between the two nodes in the node-path matrix 20. The plurality of path-based simulations 18 continue to randomly select two nodes in the selected knowledge graph 16 until each node pair in the selected knowledge graph 16 is selected or a compute limit is reached. In some implementations, the plurality of path-based simulations 18 include a single-exclusion shortest path, a personalized page-rank, and a random walk based traversal.

At 506, the method 500 includes generating a node-path matrix in response to running the plurality of path-based simulations on the knowledge graph. The pathway discovery tool 102 generates a node-path matrix 20 in response to running the plurality of path-based simulations 18 on the selected knowledge graph 16. The node-path matrix 20 identifies different connections simulated during path-based simulations 18 on the selected knowledge graph 16 and records node occurrence of the nodes identified on the different connections simulated during the path-based simulations 18. The node-path matrix 20 includes a value indicating whether a node occurs on the simulated connection (e.g., a “1” if a node is found on a connection and a “0” if a node is not located on a connection).

In some implementations, a node-path matrix 20 is generated for each path-based simulation 18 run on the selected knowledge graph 16 and the pathway discovery tool 102 generates a normalized node-path matrix 22 from the different node-path matrixes 20 generated for each path-based simulation 18. The normalized node-path matrix identifies different connections simulated during the plurality of path-based simulations on the selected knowledge graph 16 and a node occurrence of nodes identified on the different connections during the plurality of path-based simulations 18. The normalized node-path matrix 22 combines values of the node occurrence of the nodes on the different connections simulated during the plurality of path-based simulations 18 on the selected knowledge graph 16.

At 508, the method 500 includes training a probabilistic graphical model using a knowledge graph and a node-path matrix. The pathway discovery tool 102 trains a probabilistic graphical model 24 using the selected knowledge graph 16 and the node-path matrix 20. The selected knowledge graph 16 (the input dependency structure) and the node-path matrix 20 (the input data) are provided as input to the probabilistic graphical model 24 and the probabilistic graphical model 24 learns a joint probability distribution of the nodes in the selected knowledge graph 16. The marginal probability represents the distribution of the node importance values. Conditional importance of nodes may also be obtained based on the importance values observed or set for a subset of nodes. In some implementations, the probabilistic graphical model 24 is a Neural Graphical Model 36. In some implementations, the normalized node-path matrix 22 and the selected knowledge graph 16 are provided as input to train the probabilistic graphical model 24.

At 510, the method 500 includes receiving a query that identifies a node or nodes of the knowledge graph. The pathway discovery tool 102 receives a query 32 from the users 104, 106 identifying a node of the selected knowledge graph 16. The queries 32 include any question the users 104, 106 ask relating to the selected knowledge graph 16. In some implementations, the query 32 identifies a single node of interest in the selected knowledge graph 16 (e.g., an explore mode). In some implementations, the query 32 identifies two nodes of interest in the selected knowledge graph 16 (e.g., a connect mode). In some implementations, the query 32 identifies three or more nodes of interest in the selected knowledge graph 16 (e.g., a group mode). In some implementations, the query 32 excludes a node or nodes in the selected knowledge graph 16. In some implementations, the query 32 includes other exclusion criteria to consider in identifying the paths 30 in the selected knowledge graph 16.

At 512, the method 500 includes using the probabilistic graphical model to identify a path in the knowledge graph relevant to the node in the query. The pathway discovery tool 102 uses the probabilistic graphical model 24 to identify a path 30 or a plurality of paths 30 in the selected knowledge graph 16 relevant to the node or nodes in the query 32 in response to the query 32. In some implementations, the pathway discovery tool 102 uses the probabilistic graphical model 24 to identify a path 30 or a plurality of paths 30 in the selected knowledge graph 16 that exclude the node or nodes in the query 32 in response to the query 32.

The pathway discovery tool 102 uses the probabilistic graphical model 24 to provide probabilities 26 of other nodes present in the selected knowledge graph 16 based on the node importance in response to the node identified in the query 32. The pathway discovery tool 102 runs a probabilistic pathway finder algorithm on the selected knowledge graph 16 using the probabilities 26 provided by the probabilistic graphical model 24 to identify paths 30 in the selected knowledge graph 16 in response to the query 32. In some implementations, the probabilistic pathway finder algorithm sorts the predicted node importance values in identifying the paths 30. In some implementations, the probabilistic pathway finder algorithm runs weighted shortest path algorithms (with optional exclusion variants) to get important pathways. In some implementations, the probabilistic pathway finder algorithm identifies a threshold and considers paths with nodes having a probability value that exceed the threshold in identifying the paths 30.

At 514, the method 500 includes providing an output of the path in the knowledge graph in response to the query. The pathway discovery tool 102 provides an output of the paths 30 or the plurality of paths 30 in the selected knowledge graph 16 in a response 34 to the query 32. In some implementations, the identified paths 30 are important paths of the selected knowledge graph 16 (e.g., paths that include the nodes of interest identified in the query 32). In some implementations, the identified paths 30 are most likely the path that caused a connection between nodes (entities) in the selected knowledge graph 16.

The method 500 converts the selected knowledge graph 16 into a probabilistic graphical model 24 that supports probabilistic reasoning. Probabilistic reasoning over paths can be used by the users 104, 106 to discover important parts of the selected knowledge graph 16 or areas of interest of the selected knowledge graph 16.

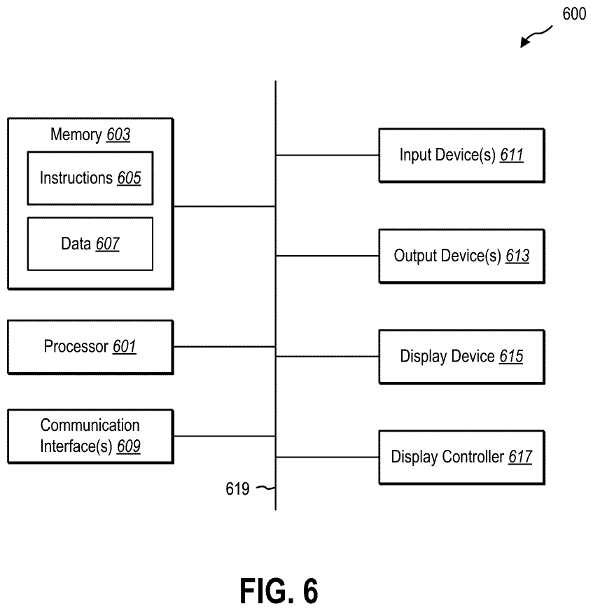

FIG. 6 illustrates components that may be included within a computer system 600. One or more computer systems 600 may be used to implement the various methods, devices, components, and/or systems described herein.

The computer system 600 includes a processor 601. The processor 601 may be a general-purpose single or multi-chip microprocessor (e.g., an Advanced RISC (Reduced Instruction Set Computer) Machine (ARM)), a special purpose microprocessor (e.g., a digital signal processor (DSP)), a graphics processing unit (GPU), a microcontroller, a programmable gate array, etc. The processor 601 may be referred to as a central processing unit (CPU). Although just a single processor 601 is shown in the computer system 600 of FIG. 6, in an alternative configuration, a combination of processors (e.g., an ARM and DSP) could be used.

The computer system 600 also includes memory 603 in electronic communication with the processor 601. The memory 603 may be any electronic component capable of storing electronic information. For example, the memory 603 may be embodied as random access memory (RAM), read-only memory (ROM), magnetic disk storage mediums, optical storage mediums, flash memory devices in RAM, on-board memory included with the processor, erasable programmable read-only memory (EPROM), electrically erasable programmable read-only memory (EEPROM) memory, registers, and so forth, including combinations thereof.

Instructions 605 and data 607 may be stored in the memory 603. The instructions 605 may be executable by the processor 601 to implement some or all of the functionality disclosed herein. Executing the instructions 605 may involve the use of the data 607 that is stored in the memory 603. Any of the various examples of modules and components described herein may be implemented, partially or wholly, as instructions 605 stored in memory 603 and executed by the processor 601. Any of the various examples of data described herein may be among the data 607 that is stored in memory 603 and used during execution of the instructions 605 by the processor 601.

A computer system 600 may also include one or more communication interfaces 609 for communicating with other electronic devices. The communication interface(s) 609 may be based on wired communication technology, wireless communication technology, or both. Some examples of communication interfaces 609 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 600 may also include one or more input devices 611 and one or more output devices 613. Some examples of input devices 611 include a keyboard, mouse, microphone, remote control device, button, joystick, trackball, touchpad, and lightpen. Some examples of output devices 613 include a speaker and a printer. One specific type of output device that is typically included in a computer system 600 is a display device 615. Display devices 615 used with embodiments disclosed herein may utilize any suitable image projection technology, such as liquid crystal display (LCD), light-emitting diode (LED), gas plasma, electroluminescence, or the like. A display controller 617 may also be provided, for converting data 607 stored in the memory 603 into text, graphics, and/or moving images (as appropriate) shown on the display device 615.

The various components of the computer system 600 may be coupled together by one or more buses, which may include a power bus, a control signal bus, a status signal bus, a data bus, etc. For the sake of clarity, the various buses are illustrated in FIG. 6 as a bus system 619.

In some implementations, the various components of the computer system 600 are implemented as one device. For example, the various components of the computer system 600 are implemented in a mobile phone or tablet. Another example includes the various components of the computer system 600 implemented in a personal computer. Another example includes the various components of the computer system 600 implemented in the cloud. Another example includes the various components of the computer system 600 implemented on an edge device.

As illustrated in the foregoing discussion, the present disclosure utilizes a variety of terms to describe features and advantages of the model evaluation system. Additional detail is now provided regarding the meaning of such terms. For example, as used herein, a “machine learning model” refers to a computer algorithm or model (e.g., a classification model, a clustering model, a regression model, a language model, an object detection model, a probabilistic graphical model) that can be tuned (e.g., trained) based on training input to approximate unknown functions. For example, a machine learning model may refer to a neural network (e.g., a convolutional neural network (CNN), deep neural network (DNN), recurrent neural network (RNN)), or other machine learning algorithm or architecture that learns and approximates complex functions and generates outputs based on a plurality of inputs provided to the machine learning model. As used herein, a “machine learning system” may refer to one or multiple machine learning models that cooperatively generate one or more outputs based on corresponding inputs. For example, a machine learning system may refer to any system architecture having multiple discrete machine learning components that consider different kinds of information or inputs.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various implementations.

Computer-readable mediums may be any available media that can be accessed by a general purpose or special purpose computer system. Computer-readable mediums that store computer-executable instructions are non-transitory computer-readable storage media (devices). Computer-readable mediums that carry computer-executable instructions are transmission media. Thus, by way of example, and not limitation, implementations of the disclosure can comprise at least two distinctly different kinds of computer-readable mediums: non-transitory computer-readable storage media (devices) and transmission media.

As used herein, non-transitory computer-readable storage mediums (devices) may include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database, a datastore, or another data structure), ascertaining and the like. Also, “determining” can include receiving (e.g., receiving information), accessing (e.g., accessing data in a memory) and the like. Also, “determining” can include resolving, selecting, choosing, establishing, predicting, inferring, and the like.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one implementation” or “an implementation” of the present disclosure are not intended to be interpreted as excluding the existence of additional implementations that also incorporate the recited features. For example, any element described in relation to an implementation herein may be combinable with any element of any other implementation described herein. Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to implementations disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the implementations that falls within the meaning and scope of the claims is to be embraced by the claims.

The present disclosure may be embodied in other specific forms without departing from its spirit or characteristics. The described implementations are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method, comprising:
training a probabilistic graphical model using a knowledge graph and a node-path matrix;
receiving a query that identifies a node of the knowledge graph;
using the probabilistic graphical model to identify a path in the knowledge graph relevant to the node in the query; and
providing an output of the path in the knowledge graph in response to the query.

2. The method of claim 1, further comprising:
using the probabilistic graphical model to determine a probability distribution of other nodes in the knowledge graph conditioned on the node in the query; and
using the probability distribution to identify the path relevant to the node in the query.

3. The method of claim 2, wherein the path includes the node in the query and other nodes with a probability value over a threshold of being on the path.

4. The method of claim 1, further comprising:
using the probabilistic graphical model to identify a plurality of paths in the knowledge graph relevant to the node in the query; and
providing the output of the plurality of paths in the knowledge graph in response to the query.

5. The method of claim 1, wherein the probabilistic graphical model learns a joint distribution over the knowledge graph and a marginal probability represents a distribution of node importance values.

6. The method of claim 1, wherein the node-path matrix identifies different connections simulated between subsets of nodes during path-based simulations on the knowledge graph and nodes identified on the different connections simulated during the path-based simulations.

7. The method of claim 6, wherein the path-based simulations randomly select two nodes in the knowledge graph as a subset of nodes and records node occurrence of the nodes identified on multiple simulated connections between the two nodes in the node-path matrix.

8. The method of claim 1, wherein the query identifies a set of nodes of the knowledge graph, and the method further comprises:
using the probabilistic graphical model to identify one or more paths in the knowledge graph relevant to the set of nodes in the query; and
providing the output of the one or more paths in the knowledge graph in response to the query.

9. The method of claim 1, wherein the query excludes a node, and the method further comprises:
using the probabilistic graphical model to identify one or more paths in the knowledge graph without the node; and
providing the output of the one or more paths in the knowledge graph in response to the query.

10. A method, comprising:
receiving a selection of a knowledge graph;
running a plurality of path-based simulations on the knowledge graph;
generating a normalized node-path matrix in response to running the plurality of path-based simulations on the knowledge graph; and
training a probabilistic graphical model using the normalized node-path matrix and the knowledge graph.

11. The method of claim 10, wherein the plurality of path-based simulations simulate different connections between a set of nodes in the knowledge graph and identify nodes in the knowledge graph on different connections in a node-path matrix.

12. The method of claim 10, wherein the plurality of path-based simulations randomly select two nodes in the knowledge graph and records nodes identified on simulated connections the two nodes in a node-path matrix.

13. The method of claim 12, wherein the plurality of path-based simulations continue to randomly select two nodes until each node pair in the knowledge graph is selected or a compute limit is reached.

14. The method of claim 10, wherein the plurality of path-based simulations include a single-exclusion shortest path, a personalized page-rank, and a random walk based traversal.

15. The method of claim 10, wherein the normalized node-path matrix identifies different connections simulated between nodes in the knowledge graph during the plurality of path-based simulations on the knowledge graph and a node occurrence of nodes identified on the different connections during the plurality of path-based simulations.

16. The method of claim 15, wherein the normalized node-path matrix combines values of the node occurrence of the nodes on the different connections simulated during the plurality of path-based simulations on the knowledge graph.

17. The method of claim 10, wherein the knowledge graph merges a plurality of knowledge graphs selected into a single knowledge graph.

18. The method of claim 17, wherein the plurality of knowledge graphs are from different domains.

19. The method of claim 17, wherein the plurality of knowledge graphs include different content or data types.

20. The method of claim 10, further comprising:
receiving a query that identifies one or more nodes of the knowledge graph;
using the probabilistic graphical model to identify a path in the knowledge graph relevant to the one or more nodes in the query; and
providing an output of the path in the knowledge graph in response to the query.
